(19) United States
(12) Patent Application Publication
(10) Pub. No.: US 2022/0316565 A1
(43) Pub. Date: Oct. 6, 2022

(54) SCREW MECHANISM PART OF A SCREW MECHANISM AND METHOD FOR THE PRODUCTION THEREOF

(71) Applicant: Schaeffler Technologies AG & Co. KG, Herzogenaurach (DE)

(72) Inventors: Yongsu Kim, Gimhae-si (KR); Dieter Adler, Schönwald (DE)

(21) Appl. No.: 17/613,188

(22) PCT Filed: Apr. 22, 2020
(86) PCT No.: PCT/DE2020/100331

§ 371 Date: Nov. 22, 2021

(30) Foreign Application Priority Data
May 24, 2019 (DE) 10 2019 003 650.6

(51) Int. Cl. F16H 25/20; F16H 25/24; F16H 25/22

(52) U.S. Cl. CPC F16H 25/2015; F16H 25/2418; F16H 25/2204

(57) ABSTRACT

A screw mechanism part (1) of a screw mechanism, which screw mechanism part is formed by a lead screw or a threaded nut (15) of the screw mechanism, has a machine part (3), which is mounted in a rotationally fixed manner on the screw mechanism part (1), for transmitting a torque. The machine part (3) and the screw mechanism part (1) have an axial overlap region (a) in which the pressing section (4) formed on the inner circumference of the machine part (3) is pressed onto external teeth or knurling (5) of the screw mechanism part (1). Inside the overlap region (a) there is formed a circumferential groove (6) which is situated axially adjacent to the external teeth or knurling (5). Material of the machine part (3) which is displaced during the pressing on is pushed into the circumferential groove (6).

### CROSS-REFERENCE TO RELATED APPLICATIONS

This application is the U.S. National Phase of PCT Appin. No. PCT/DE2020/100331 filed Apr. 22, 2020, which claims priority to DE 10 2019 003 650.6 filed May 24, 2019, the entire disclosures of which are incorporated by reference herein.

The present disclosure relates to a screw mechanism part of a screw mechanism, in particular a ball screw mechanism, which is designed as a lead screw or a threaded nut. The present disclosure also relates to screw mechanisms, in particular ball screws, which have screw mechanism parts in screw engagement with one another, one of which is formed by a threaded nut and the other by a lead screw.

The present disclosure also relates to a method for producing said screw mechanism part.

### BACKGROUND

A ball screw mechanism is known from DE102008062180 Al, with a force-transmitting connection between an annular disk and a lead screw by means of a press connection between the disk and a collar of the lead screw. The annular disk can be positioned on the collar in all angular positions. It is provided that the annular disk is pressed onto the shaft in such a position that the axial projection is received by the groove when the threaded nut is turned back and forms a stop acting in the circumferential direction.

### SUMMARY

By pressing on, displaced material can be made sharp-edged or cut off as a chip. Sharp edges can cause injuries when assembling by hand in the intended application. Chips can lead to undesired malfunctions or failure of the screw mechanism in the application.

A screw mechanism part of a screw mechanism is provided that is formed by a lead screw or a threaded nut of the screw mechanism, having a machine part which is mounted in a rotationally fixed manner on the screw mechanism part for transmitting a torque. The machine part and the screw mechanism part have an axial overlap region in which the pressing section formed on the inner circumference of the machine part is pressed onto external teeth or knurling of the screw mechanism part, wherein, inside the overlap region, there is formed a circumferential groove which is situated axially adjacent to the external teeth or knurling.

The screw mechanism part can be designed as a threaded nut, which has a groove, in particular a ball groove, wound helically around a nut axis on its inner circumference. This screw mechanism part can be designed as a lead screw which has a groove, in particular a ball groove, wound helically around a spindle axis on its outer circumference.

This screw mechanism part is connected in a rotationally fixed manner to a machine part in order to transmit a torque between the machine part and the screw mechanism part.

The machine part can be designed as a stop disk, stop ring or drive wheel and, depending on the application, is pressed either onto the lead screw or onto the threaded nut. When the machine part is pressed on, its pressing section comes into contact with the external teeth. The machine part can be designed, for example, as a drive disk or as a stop disk.

The pressing section is preferably formed by a cylindrical jacket surface on the inner circumference of the machine part. The diameter of the pressing section is smaller than the outer diameter of the teeth or knurling formed on the outer circumference of the gear part. The two diameters are matched to one another in such a way that the teeth of the external teeth or the profile of the knurling penetrate the outer surface of the pressing section when pressed axially and displace and/or cut off material.

The external teeth are preferably designed as straight teeth with axially arranged teeth. In the case of knurling, axially parallel grooves of the knurling are expedient. Axially parallel means an arrangement parallel to the axis of the screw mechanism or a parallel arrangement to the axis along which the machine part is pressed on.

With further relative displacement, the profile of the external toothing or of the knurl is pressed into the pressing section of the machine part, which is preferably formed by a cylindrical outer surface. During this pressing process, material of the machine part is plastically displaced in the region of the pressing section so that a form fit in the circumferential direction between the machine part and the lead screw ensures the proper transmission of torques between the machine part and the screw mechanism part.

In many cases, the machine part can be designed as a disk, sleeve or wheel with a central opening at which the cylindrical pressing section and the circumferential groove arranged around the cylinder axis are formed. Such machine parts can be manufactured in an economically advantageous manner.

The external teeth or knurling are preferably formed from a steel hardened in a heat treatment. The pressing section of the machine part is formed in this case from a comparatively soft material so that only the pressing section of the machine part is plastically deformed during the axial pressing.

In the event that chips are lifted from the pressing section of the machine part during pressing, a circumferential groove arranged axially adjacent to the pressing section serves as a receiving space for these chips. With the relative progress of pressing, the chips that may have been lifted off are pushed in the direction of the circumferential groove and are finally caught in it. In this way, the chips do not interfere with the proper connection between the machine part and the lead screw. Even if the displaced material is not separated, the receiving space ensures a defined position in which the displaced material remains.

A diameter of the groove base of the circumferential groove based on the screw mechanism part axis is equal to or smaller than a root diameter of the external teeth or knurling.

In this way, with a relative axial advance between the machine part and the screw mechanism part, the chips are reliably pushed into the circumferential groove.

If chips have accrued and were not or could not be removed from the circumferential groove, measures are advisable to prevent these chips from escaping from the screw mechanism in order to ensure proper operation in the application.

A preferred measure provides that the circumferential groove is arranged axially between the pressing section and a seal formed between the machine part and the lead screw. This seal prevents unwanted exit of the chips from the screw mechanism and the chips remain in the circumferential groove.

The seal can have a sealing ring which is inserted into an annular gap formed between the machine part and the screw mechanism part. For example, the machine part can have an axially smooth cylindrical bore and the sealing ring can be inserted into the bore. The annular gap is closed by this seal to such an extent that the above-mentioned chips cannot fall out through this annular gap.

The seal can also be formed in that a ring or bead arranged around the axis of rotation of the screw mechanism is formed on the outer circumference of the screw mechanism part. The outer diameter of this ring or the bead forms a first sealing surface. The outer diameter is somewhat smaller than an inner diameter of a cylindrical second sealing surface which is formed on the inner circumference of the machine part. Any remaining annular gap is so small that any chips that may arise cannot escape through this remaining annular gap.

The invention also comprises a screw mechanism with two screw mechanism parts arranged in screw engagement, which are formed by a lead screw and a threaded nut, and one of which works together with the machine part in the manner described. This screw mechanism is preferably formed by a ball screw mechanism, the balls of which roll on ball grooves that are helically wound around the longitudinal axis, the ball grooves being formed on mutually facing peripheral surfaces of the lead screw and the threaded nut.

BRIEF SUMMARY OF THE DRAWINGS

The invention is explained in more detail on the basis of two exemplary embodiments shown in a total of five figures. In the figures:

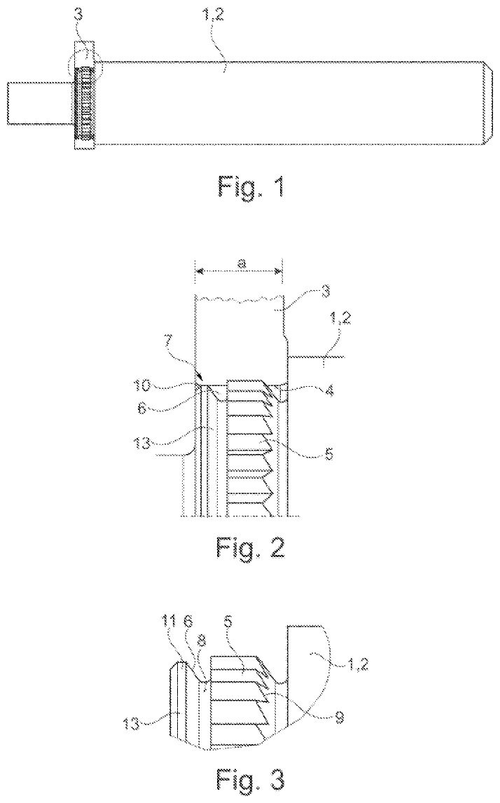

FIG. 1 shows a screw mechanism part designed as a lead screw with a pressed-on machine part in a view

FIG. 2 shows an enlarged section from FIG. 1

FIG. 3 shows a representation as in FIG. 2 but without a machine part

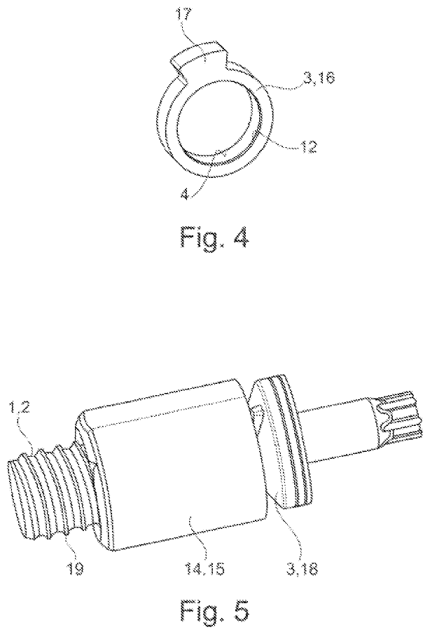

FIG. 4 shows the machine part from FIG. 1 designed as a stop ring in a perspective illustration

FIG. 5 shows a ball screw mechanism in a perspective illustration, with a threaded nut arranged on the lead screw and with a machine part designed as a stop disk and pressed onto the lead screw.

### DETAILED DESCRIPTION

FIGS. 1 to 4 show a screw mechanism with a screw mechanism part 1 which is formed by a lead screw 2. A machine part 3 for transmitting a torque is arranged in a rotationally fixed manner on the screw mechanism part 1. The machine part 3 and the screw mechanism part 1 have an axial overlap region (a) in which the pressing section 4 formed on the inner circumference of the machine part 3 is pressed onto the knurling 5 of the screw mechanism part 1. Inside the overlap region (a) there is formed a circumferential groove 6 which is situated axially adjacent to the knurling 5.

The circumferential groove 6 is arranged axially between the knurling 5 and a seal 7 formed between the screw mechanism part 1 and the machine part 3. The circumferential groove 6 is formed on the screw mechanism part 1 and axially adjoins the knurling 5 directly. A groove base 8 of the circular circumferential groove 6 has a diameter related to the screw mechanism part axis which is equal to or smaller than a root diameter 9 of the knurling 5.

The seal 7 forms an annular sealing gap 10, which is delimited by a first sealing surface 11 of the screw mechanism part 1 and by a cylindrical second sealing surface 12 of the machine part 3. The first sealing surface 11 is formed on an annularly closed ring section 13 of the screw mechanism part 1, which can also be referred to as a bead.

The machine part 3 designed as a stop ring 16 is provided with the second cylindrical sealing surface 12 on its inner circumference at one axial end of the axial overlap section (a), and, at the opposite other axial end of the axial overlap section (a), with the cylindrical pressing section 4. The second cylindrical sealing surface 12 and the cylindrical pressing section 4 are arranged axially directly adjacent to one another and have diameters of different sizes. The second cylindrical sealing surface 12 and the cylindrical pressing section 4 can alternatively lie on a common diameter.

On the outer circumference of the stop ring 16, a cam-shaped stop 17 is formed for the circumferential stop against a counter-stop, which is arranged on a threaded nut, not shown, or on a machine part connected in a rotationally fixed manner to the threaded nut.

The lead screw 2 with the knurling 5 is made of a steel hardened in a heat treatment and the machine part 3 with the pressing section 4 is made of a comparatively soft material. When the machine part 3 is pressed onto the knurling 5, the material of the pressing section 4 is plastically deformed and pushed in the direction of the circumferential groove. Any chips of the machine part 3 that may be produced are forced towards and into the circumferential groove 6 under the relative displacement between the machine part 3 and the lead screw 2. The chips are received in the circumferential groove 6 in a captive manner. In the sliding direction of the machine part 3, the circumferential groove 6 is located in front of the knurling 5. Chips produced preferably do not reach the axial side of the knurling 5 facing away from the seal 7.

FIG. 5 shows a screw mechanism designed as a ball screw mechanism with the machine part 3 pressed onto the lead screw 2, which is designed here as a stop disk 18. A threaded nut 15 is arranged on the lead screw 2 as a threaded drive part 14. A ball groove 19 wound helically around the spindle axis can be clearly seen on which balls, not shown, roll off, which are arranged between the lead screw 2 and the threaded nut 15. The connection in a rotationally fixed manner between the stop disk 18 and the lead screw 2 is implemented in the same way as in the embodiment described above.

### LIST OF REFERENCE SYMBOLS

Screw mechanism part
Lead screw
Machine part
Pressing section
Knurling
Circumferential groove
Seal
Groove base
Root diameter
Sealing gap
First sealing surface
Second sealing surface
Ring section
Screw mechanism part
Threaded nut
Stop ring
Stop
Stop disk
Ball groove

What is claimed is:

1. A screw mechanism part of a screw mechanism, the screw mechanism part being a lead screw or a threaded nut of the screw mechanism, having a machine part which is mounted in a rotationally fixed manner on the screw mechanism part for transmitting a torque, the machine part and the screw mechanism part having an axial overlap region in which a pressing section formed on an inner circumference of the machine part is pressed onto external teeth or knurling of the screw mechanism part, wherein, inside the overlap region, there is formed a circumferential groove which is situated axially adjacent to the external teeth or knurling.

2. The screw mechanism part according to claim 1, wherein the circumferential groove is arranged axially between the external teeth or knurling and a seal formed between the screw mechanism part and the machine part.

3. The screw mechanism part according to claim 1, wherein the circumferential groove is formed on the screw mechanism part and axially adjoins the external teeth or knurling directly.

4. The screw mechanism part according to claim 3, wherein the circumferential groove has a groove base, the groove base having a diameter based on the screw mechanism part axis that is equal to or smaller than a root diameter of the external teeth or knurling.

5. The screw mechanism part according to claim 2, wherein the seal forms an annular sealing gap, which is delimited by a first sealing surface of the screw mechanism part and by a cylindrical second sealing surface of the machine part.

6. The screw mechanism part according to claim 5, wherein the first sealing surface is formed on an annularly closed ring section of the screw mechanism part.

7. The screw mechanism part according to claim 5, wherein the machine part is provided with the second cylindrical sealing surface on its inner circumference at one axial end of the axial overlap region and, at an opposite other axial end of the axial overlap section, with the pressing section.

8. The screw mechanism part according to claim 7, wherein the second cylindrical sealing surface and the pressing section are arranged axially directly adjacent to one another and have diameters of the same size or different sizes.

9. A screw mechanism comprising:
the screw mechanism part according to claim 1, which is designed as a rotatably drivable lead screw, on which the threaded nut is arranged in screw engagement.

10. A method for producing a screw mechanism comprising:
providing a screw mechanism part, the screw mechanism part being a lead screw or a threaded nut of a screw mechanism; and
pressing a machine part onto the screw mechanism part with axial feed, wherein external teeth or knurling of the screw mechanism part displaces material of a pressing section, and wherein any chips of the machine part that may be produced under a relative displacement between the machine part and the screw mechanism part are pressed in a direction of a circumferential groove situated axially adjacent to the external teeth or knurling and brought into the circumferential groove.

11. A screw mechanism comprising:
a screw mechanism part, the screw mechanism part being a lead screw or a threaded nut of a screw mechanism; and
a machine part mounted in a rotationally fixed manner on the screw mechanism part for transmitting a torque, the machine part and the screw mechanism part have an axial overlap region in which a pressing section formed on an inner circumference of the machine part is pressed onto external teeth or knurling of the screw mechanism part, a circumferential groove being formed inside the overlap region and situated axially adjacent to the external teeth or knurling, the circumference groove being configured for receiving chips formed during pressing of the machine part onto the screw mechanism part.

12. The screw mechanism as recited in claim 11 wherein the machine part is a stop ring.

13. The screw mechanism as recited in claim 12 wherein the circumferential groove is arranged axially between the external teeth or knurling and a seal, the seal being formed within the overlap region by an outer circumferential surface of the screw mechanism part and an inner circumferential surface of the stop ring.

14. The screw mechanism as recited in claim 12 wherein the stop ring including a cam-shaped stop on an outer circumference of the stop ring.

15. The screw mechanism as recited in claim 11 wherein the pressing section of the machine part is formed of a softer material than external teeth or knurling of the screw mechanism part.

16. The screw mechanism as recited in claim 11 wherein the screw mechanism is a ball screw mechanism.

17. The screw mechanism as recited in claim 11 wherein the screw mechanism part is a lead screw, the screw mechanism further comprising the threaded nut arranged on the lead screw as a threaded drive part.
